(19) United States
(12) Patent Application Publication
(10) Pub. No.: US 2010/0260893 A1
(43) Pub. Date: Oct. 14, 2010

(54) Composition comprising polyunsaturated fatty acids and activated charcoal

(76) Inventor: Catherine Kabaradjian, Vetraz-Monthoux (FR)

Correspondence Address: BAYER HEALTHCARE LLC;CONSUMER CARE DIVISION, 36 COLUMBIA ROAD, MORRISTOWN, NJ, 07962, US

(21) Appl. No.: 12/799,744

(22) Filed: Apr. 30, 2010

(30) Foreign Application Priority Data
Oct. 30, 2007 (EP) 07291306.4
Oct. 21, 2008 (EP) PCT/EP2008/008882

(51) Int. Cl. A23L 1/29; A23L 1/302; A23L 1/304; A23D 9/00

(52) U.S. Cl. 426/72; 426/601

(57) ABSTRACT

An oral composition without bad odor, smell or taste comprising polyunsaturated fatty acids (PUFAs) and activated charcoal, process for preparation and use of the composition as a nutritional supplement or as a dietary supplement for balancing blood lipid levels and preventing or reducing the risk of developing atherosclerotic changes, disorders or diseases.

### BACKGROUND OF THE INVENTION

1. Field of the Invention

This invention relates to an oral composition comprising polyunsaturated fatty acids and activated charcoal, its process for preparation and its use as a nutritional or dietary supplement for promoting balanced blood lipid levels and preventing or reducing the risk of the development of atherosclerotic changes, disorders or diseases. The composition does not have the unpleasant odor, smell, or taste often associated with polyunsaturated fatty acids obtained from various sources.

2. Description of Related Art

Polyunsaturated fatty acids (“PUFAs”) are found in fish oil and may be responsible for reducing blood lipid levels. Lower blood lipid levels, in turn, may reduce hypertension as suggested by an epidemiological study carried out among the Inuits (M. H. Davidson, P. R. Liebson, “Marine Lipids and Atherosclerosis: A Review,” Cardiovascular Reviews & Reports, Vol. 7, No. 5, (1986)). In particular, the blood concentration of low density lipoprotein cholesterol (LDL) is lowered and the high density lipoprotein cholesterol (HDL) is increased among people consuming a diet with high levels of PUFAs. Coronary heart disease (CHD) is a major cause of death in the western countries, and high plasma cholesterol levels, especially when coupled with an unfavorable LDL/HDL ratio, is highly correlated with the risk of CHD (Willett, W. and Sacks, F., “Chewing the fat—how much and what kind?” N. Eng. J. Med., vol. 324(2) p. 121-23 (1991)).

The PUFAs found in fish oil have chains of 18, 20 or 22 carbon atoms and can be classified as n-3 omega and n-6 omega fatty acids, which are essential for the human body. In particular the omega-3 fatty acids eicosapentenoic acid (EPA) and docosahexenoic acid (DHA) are only found in fish and other marine life. Fish oil is therefore a very important food source for omega-3 fatty acids.

Standard nutritional supplement regimens that include supplements containing PUFAs generally call for a daily administration of from about 500 to about 1,000 mg of liquid fish oil. This amount of fish oil is normally contained in one or more (but usually one or two) capsules, tablets, or softgels. These dosage forms provide advantages over liquids because they are more convenient and because they can be used with various technologies to limit the fishy smell and odor often associated with PUFAs.

Even with capsules, tablets or softgels, some people still experience gastrointestinal upset due to a perceived fishy smell or taste, even hours after the fish oil has been consumed. One possible explanation for the source of this perceived fishy smell or taste is that when, for example, a capsule containing fish oil dissolves in the gastro-intestinal tract, the entire voluminous dosage of the fish oil is released as a macroscopic drop that can delay and interfere with the absorption of the fish oil through the normal digestive process. The fish oil may thus exude a fishy smell or taste that can be perceived by the consumer.

Various solutions to the problems posed by the fishy smell and odor (and the delayed absorption of the PUFAs) have been tried. Microdispersed fish oil preparations as a pulverulent or aqueous matrix, as described in European Patent No. 276,772 to Horn et al., published Jul. 15, 1992, were prepared by first preemulsifying a fish oil together with a surfactant, a protective colloid, and water in a conventional high-speed stirrer. The resulting mixture was then emulsified in a high pressure homogenizer to reduce the average diameter of the oil droplets below 10 μm. This formulation requires multiple extra processing steps, which can increase costs in a commercial process, and the microdispersed fish oil granules or powder can still have a fishy smell when pressed in simple tablets, so that flavors or antioxidants must be added to the formulations as taste and smell masking agents.

The fishy smell of the PUFAs appears to arise as a product of the oxidation of the unsaturated bonds in the PUFAs. Antioxidants, such as tocopherol, have been added to formulations containing PUFAs, and appear to prevent or delay oxidation and stabilize the PUFAs, as described in German Patent No. 20105126 to Bartz and European Patent No. 1,155,620 to Lystrup et al. (corresponding to U.S. Published Application No. US 2003/165596 to Lystrup, K., et al., published Sep. 4, 2003).

Some acceptable added flavors to mask the fishy smell of the fish oil are described in Japanese Patent Publication No. JP 08092587 (Shuichiro, U., et al., Published Apr. 9, 1996) or Japanese Patent Publication No. JP 08228678 (Yamashita, M., et al., Published Sep. 10, 1996). Taste masking may also be carried out by adding milk products to a fish oil formulation (as described in US Patent Publication No. 2003/0198728 to Sundram, K. et al, Published Oct. 23, 2003, and as described in Japanese Patent Publication No. JP 2002-204656, to Ogasawara, N., et al., published Jul. 23, 2002) or by coating or encapsulating the PUFAs (as described in PCT Publication No. WO 2004/016720 (also published as US Patent Publication No. 2006/068019 to Dalziel, S. et al., Published Mar. 30, 2006) and WO 2005/029978 (also published as U.S. Patent Publication No. 2007/031475 to Kuslys, M. et al., Published Feb. 8, 2007).

Despite attempts to mask the fishy odor that may come from oxidizing PUFAs and despite the efforts to delay or prevent the oxidization of the PUFAs, a need in the art remains for an oral composition providing the benefits of PUFAs without the unpleasant smell and taste associated with PUFAs, preferably without causing a substantial increase in the manufacturing cost of a commercial product containing one or more PUFAs.

### SUMMARY OF THE INVENTION

The principal object of the invention therefore is to provide an oral composition containing at least one PUFA, having no unpleasant fishy odor or smell.

Another object of the invention is to provide a method for making an oral composition containing at least one PUFA, where the composition has no unpleasant fishy odor or smell.

An advantage of the invention is that the oral composition may be made without employing complex and expensive taste masking technology.

Another advantage of the invention is that any bad or fishy smell, odor or taste, is controlled, even after storage of several weeks, and the composition can be prepared without any added flavor or antioxidant.

Additional objects and advantages of the invention will be set forth in part in the description that follows, and in part will be obvious from this description, or may be learned by practice of the invention. The objects and advantages of the invention may be realized and attained by means of the instrumentalities and combinations particularly pointed out in the appended claims.

To achieve the foregoing objects and in accordance with the purpose of the invention, as embodied and broadly described herein, the invention provides an oral composition comprising at least one polyunsaturated fatty acid (PUFA) and activated charcoal. The oral composition does not have a fishy or bad smell, odor or taste.

The invention further provides a method for making a single or multilayer tablet or caplet comprising at least one polyunsaturated fatty acid (PUFA) and activated charcoal.

### BRIEF DESCRIPTION OF THE DRAWINGS

FIG. 1 shows a side view of a tablet made in accordance with the invention.

### DESCRIPTION OF THE PREFERRED EMBODIMENTS

Reference will now be made to the presently preferred embodiments of the invention.

The invention comprises an oral composition comprising at least one PUFA. Acceptable PUFAs include, but are not limited to, fish oil, perilla oil, omega-3 fatty acids, omega-6-fatty acids, arachidonic acid, linoleic acid, alpha-linoleic acid, dihomogammalinoleic acid, eicosapentenoic acid (EPA), docosahexenoic acid (DHA) and mixtures thereof. Preferred PUFAs include fish oil, omega-3 fatty acids, eicosapentenoic acid (EPA), docosahexenoic acid (DHA) and mixtures thereof. Most preferably the PUFA is a fish oil comprising eicosapentenoic acid (EPA) and docosahexenoic acid (DHA).

The oral composition of the invention may comprise one or more PUFAs in liquid form or in the form of a fish oil powder or granulate prepared using techniques well known in the art. The PUFAs may comprise any amount of the fill of an individual capsule or softgel or of the material to be compressed to form a tablet or caplet, but preferably the one or more PUFAs, in aggregate, comprise from about 5% to about 70% by weight of the fill or material to be compressed, more preferably from about 40% to about 60% by weight and most preferably about 50% by weight of the fill. The total amount of the PUFAs, preferably in the form of a fish oil powder or granulate, used in the composition is preferably from about 100 mg to about 1,000 mg in each capsule, softgel or tablet, preferably from about 400 mg to about 900 mg in each capsule, softgel or tablet, and most preferably from about 500 mg to about 750 mg in each capsule, softgel or tablet.

In a highly preferred embodiment the invention, the PUFA comprises eicosapentenoic acid (EPA) in an amount of from about 0.5% to about 10% by Weight, preferably from about 1.5% to about 4% by weight, of the total fill of an individual capsule or softgel or of the material to be compressed to form a tablet. In a similarly highly preferred embodiment of the invention, the EPA comprises from about 1% to about 20% by weight, and more preferably from about 3% to about 8% by weight, of the fish oil powder or granulate to be used as part of the fill of an individual capsule or softgel or as part of the material to be compressed to form a tablet. The total amount of EPA in each capsule, softgel or tablet in accordance with the invention is preferably from about 10 mg to about 100 mg per capsule, softgel or tablet, and more preferably from about 15 mg to about 50 mg. per capsule, softgel or tablet.

In another preferred embodiment of the invention, docosahexenoic acid (DHA) comprises from about 0.5% to about 10% by weight, preferably from about 1% to 4% by weight, of the total fill of an individual capsule or softgel or of the material to be compressed to form a tablet. In a preferred embodiment, the DHA comprises from about 1% to about 20% by weight, and preferably from about 2% to about 6% by weight, of the fish oil powder or granulate to be used as part of the fill of an individual capsule or softgel or to be used as part of the material to be compressed to form a tablet. The total amount of DHA in each capsule, softgel or tablet is preferably from about 10 mg to about 50 mg, and more preferably from about 15 mg to about 30 mg.

The PUFA, particularly when present as a fish oil containing eicosapentenoic acid (EPA) and docosahexenoic acid (DHA), may preferably be used in microdispersed form as a granulate or powder, in a pulverulent or aqueous matrix as described in European Patent No. 276,772, the contents of which are incorporated herein by reference. Granulate and powder forms are especially preferred.

When the PUFA is present as a pulverulant matrix of a powder or granulate, the composition may further comprise a protective colloid (preferably a homogenous protective colloid) and a surfactant. The composition may also comprise diluents, stabilizers and other ingredients, such as excipients, known and used in the art of making tablets, capsules and softgels. When the PUFA is present in an aqueous matrix, the colloid, surfactant, and other appropriate ingredients may be present as part of an aqueous solution.

The protective colloids of the invention may be polypeptides such as gelatine, casein, caseinate, polysaccharides such as starch, dextrin, pectin, Arabic gum, milk, milk powder, polyvinyl alcohols, polyvinylpyrrolidone, vinylpyrrolidone-vinylacetate-copolymers, acrylic acid- and methacrylic acid-copolymers with acrylic acid- or methacrylic acid esters, methyl cellulose, carboxymethyl cellulose, hydroxypropyl cellulose, alginates, other like materials, and mixtures thereof.

Diluents include sugars, sugar alcohols such as saccharose and lactose, invert sugars, sorbitol, mannitol and glycerine.

Stabilizers for a pulverulant matrix may include tocopherol, t-butyl hydroxytoluol, t-butyl hydroxyanisol and ethoxyquine.

Surfactants may include esters of long chain fatty acids and ascorbic acid, esters of mono- and diglycerin and fatty acids and oxethylated derivatives thereof, esters of mono fatty acid glycerides with acetic acid, citric acid, lactic acid, diacetyltartrate, salts of 2-(2′-stearoyllactyl) lactic acid, polyglycerine fatty acid esters, sorbitan fatty acid esters, propylenglycol-fatty acid esters, ascorbylpalmitate and lecithin.

The pulverulant matrix preferably comprises from about 5% to about 70%, and more preferably from about 50% to about 60%, by weight PUFA (preferably as fish oil), from about 1% to about 30%, preferably about 5% to about 15%, by weight of one or more surfactant, from about 5% to about 50%, preferably from about 10% to about 40% by weight, of a protective colloid, and from about 0% to about 70%, preferably from about 3% to about 35% by weight, of a diluent, measured by weight of the dry mass of the fish oil powder or granulate.

In a preferred embodiment, the pulverulant matrix comprises fish oil in small particles such as a powder or granulate having an average particle size of less than about 10 μm, more preferably less than about 1 μm, and most preferably less than about 0.5 μm. The fish oil powder or granulate can be prepared as described in European Patent No. 276,772.

The composition also comprises activated charcoal in an amount from about 0.1% to about 10% by weight of the composition, and preferably from about 1% to about 5% by weight of the composition. The total amount of activated charcoal in the composition will be affected by the amount of PUFAs present in the composition, but the amount of activated charcoal in each capsule, tablet or softgel is preferably from about 5 mg to about 200 mg, and more preferably from about 10 mg to about 100 mg.

The activated charcoal preferably is used in particulate form and at least about 90% of the particles should preferably have a particle size of less than about 100 μm.

The activated charcoal acts to absorb any bad or fishy smell, odor or taste associated with the PUFAs.

The composition may also comprise additional nutritionally useful active ingredients such as vitamins and minerals. Acceptable vitamins include, but are not limited to, vitamin A, beta carotene, vitamin C (ascorbic acid), vitamin D3 (cholecalcipherol), vitamin E (tocopherol acetate), vitamin B1 (thiamine), vitamin B2 (riboflavin), nicotinamide, vitamin B5 (panthothenic acid), vitamin B6 (pyridoxine), folic acid, vitamin B12 (cyanocobalamin), vitamin K1, vitamin K2, especially menaquinone 7-10, and biotin. Acceptable minerals include, but are not limited to, iron salts, copper salts, calcium salts such as calcium carbonate, calcium phosphate, calcium glycerophosphate; magnesium salts such as magnesium phosphate, magnesium sulphate (dihydrate) or magnesium oxide; zinc salts such as zinc citrate; selenium salts such as sodium selenate; potassium iodide; manganese salts such as manganese sulphate; molybdate salts such as sodium molybdate; chromium salts such as chromium chloride; sodium chloride and potassium chloride.

The composition may be used as a nutritional supplement or as dietary supplement for balancing the blood lipid level, preventing or reducing the risk of the development of atherosclerotic changes, disorders or diseases in a patient. The composition may also be used as a nutritional or dietary supplement for developing and maintaining the cognitive functions connected with, e.g., eyes, memory, language and the like or for alleviating and/or preventing blood vessel diseases, cardiovascular, cerebrovascular and nervous diseases such as, e.g., hypertension, cardiac infarction, Alzheimer's disease, Parkinson's disease and depression, or for alleviating hormonal, immunologic disorders or obesity. In addition, the composition may be used as a nutritional or dietary supplement to support treatments of diabetes, cancer and/or inflammatory conditions. A patient may be a mammal, including a human being. The nutritional or dietary supplement is especially preferred for use with pregnant women, children, and elderly persons.

The invention comprises a method for balancing blood lipid levels, preventing or reducing the risk of the development of atherosclerotic changes, disorders or diseases, for developing and maintaining the cognitive functions connected with e.g. eyes, memory, language etc., for alleviating and/or preventing blood vessel diseases, cardiovascular, cerebrovascular and nervous diseases such as, e.g., hypertension, cardiac infarction, Alzheimer's disease, Parkinson's disease and depression, or for alleviating hormonal, immunologic disorders or obesity or for supporting treatments of diabetes, cancer and/or inflammatory afflictions. The method comprises administering the inventive composition as a nutritional supplement or as dietary supplement to a patient. The patient may be a mammal, including a human being, and is especially preferred for use with pregnant women, children and elderly persons.

The composition may be administered orally, preferably in a dosing regimen of one or more times per day, more preferably up to three times per day, and most preferably up to two times per day. While the composition may be prepared in any dosage size capable of being consumed, preferably no more than two tablets, capsules or softgels are administered each time. Nevertheless, it may in some cases be advantageous to deviate from the amounts specified, depending on body weight, individual patient reactions to the active ingredient, type of preparation and time or interval over which the regimen is to be carried out. Less than the minimum dosage regimen may be sufficient in some cases, and more than the maximum amount may be administered if appropriate.

Additional ingredients may be incorporated into the oral dosage form. These ingredients are generally known and used with pharmaceuticals and nutritional supplements and are physiologically unobjectionable. Examples of such materials include fillers such as cellulose derivatives (such as microcrystalline cellulose), sugars (such as lactose), sugar alcohols (such as mannitol and sorbitol), inorganic fillers (such as calcium phosphates), binders (such as polyvinylpyrrolidone, gelatin, starch derivatives and cellulose derivatives), and other excipients normally used to prepare pharmaceutical formulations and nutritional supplements of the desired properties, including lubricants (such as magnesium stearate), disintegrants (such as crosslinked polyvinylpyrrolidone and sodium carboxymethylcellulose), wetting agents (such as sodium lauryl sulphate), release-slowing agents (such as cellulose derivatives and polyacrylic acid derivatives), pigments, and effervescent couples if the composition is an effervescent material.

Some generally known materials useful for pharmaceutical and nutritional supplements, including excipients, are described in the “Handbook of Pharmaceutical Excipients,” Rowe R. C., Sheskey P. J. & Weller, P. J., American Pharmaceutical Association, Washington, 4th edition (2003).

The composition may be in the form of a tablet, a coated tablet, a multilayer tablet, a tablet with coated granules, a core tablet, a coat-core tablet or immediate, slow and timed release preparations. Tablets, coated tablets or multilayer tablets are preferred. Most preferably the composition is a tablet. The tablet may be a single layer tablet, in which the activated charcoal is dispersed in the matrix of the tablet, or a multi-layer tablet (preferably a three-layer tablet) where the activated charcoal is present in at least one of the outer layers of the tablet. For a coated tablet, the activated charcoal may be present in the coating.

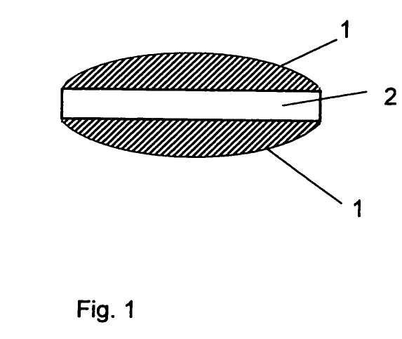

FIG. 1 shows a three-layer tablet in which the activated charcoal is present in the two outer layers (1) and the PUFA is present in the inner layer (2).

The composition may be produced by standard processes. Tablets, for example can be produced by mixing and/or granulating the active ingredients together with appropriate excipients to form a blend that is then pressed into tablets. Different blends, containing different ingredients and excipients, can be premixed and combined to form a final blend that may then be pressed into tablets, or the premixtures can be pressed into a multilayer tablet. If the tablet is an effervescent formulation, the effervescent couple can be added to final blend or the individual members of the couple may be added to one blend at different times. The members of the couple can also be added to different blends that are then combined and compressed into a tablet.

The composition shows a good and/or fast absorption of the PUFA after administration of the composition. Furthermore, the composition may be taken quickly, optionally without water or drink. The composition shows an acceptable hardness and friability so it may be manufactured without affecting the dosage form integrity, i.e., no PUFA exudes from the tablet matrix. The composition does not require (but may use, if desired) the complex and expensive taste masking technologies known in the art such as coating of granules, adding of antioxidants to the composition, or putting the PUFA into a capsule. The composition does not require the addition of flavors in order to cover and mask the bad smell. Taste masking techniques normally require certain strong flavors to mask taste and smell. But, the composition of the invention may contain flavors as optional ingredients, and the choice of flavor is not limited by the demands of taste masking.

### Example 1

A three-layered tablet was prepared having two outer layers and an inner layer.

The inner layer contained 600 mg of dry fish oil powder (omega-3, 18:12) including 28.2 mg of EPA and 20 mg of DHA, 64 mg of anhydrous dibasic calcium phosphate, 40 mg of cyclodextrin, 40 mg of hydroxypropylcellulose, 40 mg of bentonite, 4 mg of silicon dioxide, 4 mg of magnesium stearate, and 8 mg of deodorized rosemary extract.

The outer layers each contained 25 mg of activated charcoal (90% of the particles have a particle size less then 100 μm, loss on ignition at 600° C.: ≦1%, loss on drying: ≦10%), 25 mg of hydroxypropylcellulose, and 50 mg of microcrystalline cellulose.

The ingredients for the inner layer were mixed together in a tumble mixer for 20 min. Five minutes before the end of mixing, the magnesium stearate was added to give a final blend that was fed into a multilayer tablet press to form the middle layer of the multilayer tablet. The ingredients of the outer layer were mixed together in a tumble mixer for 20 min. The resulting blend was then divided and fed into a multilayer tablet press to form the outer layers of the tablet. The three layer tablet was then formed by pressing in a rotary press.

### Example 2

A tablet was prepared containing 600 mg of dry fish oil powder (omega-3, 18:12) including 28.2 mg of EPA and 20 mg of DHA, 64 mg of anhydrous dibasic calcium phosphate, 40 mg of cyclodextrin, 40 mg of hydroxypropylcellulose, 40 mg of bentonite, 4 mg of silicon dioxide, 4 mg of magnesium stearate, 8 mg of deodorized rosemary extract, 50 mg of activated charcoal (90% of the particles have a particle size less then 100 μm, loss on ignition at 600° C.: ≦1%, loss on drying: ≦10%), 50 mg of hydroxypropylcellulose, and 100 mg of microcrystalline cellulose.

The ingredients were mixed together in a tumble mixer for 20 minutes. Five minutes before the end of mixing, the magnesium stearate was added. The final blend was then pressed into tablets with a rotary press.

### Example 3

A coated tablet was prepared with a core containing 600 mg of dry fish oil powder (omega-3, 18:12) including 28.2 mg of EPA and 20 mg of DHA, 348 mg of anhydrous dibasic calcium phosphate, 48 mg of cyclodextrin, 60 mg of hydroxypropylcellulose, 60 mg of bentonite, 60 mg of povidone (kollidon VA 60 fine), 6 mg of silicon dioxide, 6 mg of magnesium stearate, and 12 mg of deodorized rosemary extract. The coating for the tablet contained 15.5 mg of activated charcoal (90% of the particles have a particle size less then 100 μm, loss on ignition at 600° C.: ≦1%, loss on drying: ≦10%), 15 mg of schellac, 22.5 mg of hydroxypropylmethylcellulose, and 9 mg of triacetine.

All the ingredients of the core were mixed together in a tumble mixer for 20 minutes. Five minutes before the end of mixing, the magnesium stearate was added. The core blend was pressed into tablets with a rotary press. A coating material was formed by making a suspension of the coating materials and water. The tablets were coated with the coating suspension.

Examples 1, 2 and 3 do not show any bad or fishy taste or smell.

The purpose of the above description is to illustrate some embodiments of the present invention without implying a limitation. It will apparent to those skilled in the art that various modifications and variations may be made in the apparatus or procedure of the invention without departing from the scope or spirit of the invention.

What is claimed is:

1. An oral composition comprising at least one polyunsaturated fatty acid and activated charcoal.

2. The composition of claim 1, wherein said at least one polyunsaturated fatty acid is selected from the group consisting of fish oil, perilla oil, omega-3 fatty acids, omega-6-fatty acids, arachidonic acid, linoleic acid, alpha-linoleic acid, dihomogammalinoleic acid, eicosapentenoic acid (EPA), docosahexenoic acid (DHA) and mixtures thereof.

3. The composition of claim 2, wherein said at least one polyunsaturated fatty acid comprises fish oil and wherein said fish oil comprises eicosapentenoic acids (EPA) and docosahexenoic acid (DHA).

4. The composition of claim 3, wherein said fish oil is in the form of a powder or granulate.

5. The composition of claim 2, wherein the amount of said at least one polyunsaturated fatty acid comprises from about 5% to about 70% by weight of said composition.

6. The composition of claim 2, wherein said composition comprises from about 100 mg to about 1,000 mg of said at least one polyunsaturated fatty acid.

7. The composition of claim 2, further comprising at least one ingredient selected from the group consisting of vitamins, minerals and combinations thereof.

8. The composition of claim 2 in a form suitable for oral administration to a patient.

9. The composition of claim 8, in the form of a tablet, a coated tablet or a multilayer tablet, wherein said form comprises a matrix of said at least one polyunsaturated fatty acid.

10. The composition of claim 9, wherein said activated charcoal is dispersed in the matrix of said tablet, coated tablet or said multilayer tablet.

11. The composition of claim 9, wherein said multilayer tablet is a three-layer tablet, and wherein said activated charcoal is in the two outer layers.

12. The composition of claim 9, wherein said activated charcoal is in the coating said coated tablet.

13. The use of the composition of claim 1 as a nutritional supplement or as dietary supplement as part of a regimen for a patient to balance the blood lipid level, preventing or reducing the risk of the development of atherosclerotic changes, disorders or diseases, for developing and maintaining the cognitive functions, for alleviating and/or preventing blood vessel diseases, cardiovascular, cerebrovascular and nervous diseases, for alleviating hormonal, immunologic disorders or obesity, for supporting treatments of diabetes, cancer and/or the inflammatory afflictions of said patient.

14. A method for balancing the blood lipid level, preventing or reducing the risk of the development of atherosclerotic changes, disorders or diseases, for developing and maintaining the cognitive functions, for alleviating and/or preventing blood vessel diseases, cardiovascular, cerebrovascular and nervous diseases, for alleviating hormonal, immunologic disorders or obesity, for supporting treatments of diabetes, cancer and/or inflammatory afflictions by administering the composition of claim 1 as a nutritional supplement or as dietary supplement.
